(19) United States
(12) Patent Application Publication
(10) Pub. No.: US 2016/0379754 A1
(43) Pub. Date: Dec. 29, 2016

(54) METHOD FOR PRODUCING A FERROMAGNETIC COMPONENT FOR A TORQUE SENSOR OF A VEHICLE STEERING SHAFT, AND TORQUE SENSOR

(71) Applicant: VALEO SCHALTER UND SENSOREN GMBH, Bietigheim-Bissingen (DE)

(72) Inventors: Dirk Rachui, Bietigheim-Bissingen (DE); Ekkehart Froehlich, Bietigheim-Bissingen (DE)

(73) Assignee: VALEO Schalter und Sensoren GmbH, Bietigheim-Bissingen (DE)

(21) Appl. No.: 15/039,516

(22) PCT Filed: Nov. 3, 2014
(86) PCT No.: PCT/EP2014/073599

§ 371 Date: May 26, 2016

(30) Foreign Application Priority Data
Nov. 27, 2013 (DE) 10 2013 019 787.2

(51) Int. Cl. H01F 41/02; C21D 8/12; C21D 3/04; B21D 53/00; C23C 22/68; G01L 3/10; G01L 5/22; C21D 9/32; C23C 8/18

(52) U.S. Cl. CPC H01F 41/0253; C21D 9/32; C21D 8/1277; C21D 8/1244; C21D 8/1216; C21D 3/04; C23C 8/18; C23C 22/68; G01L 3/104; G01L 5/221; B21D 53/00

(57) ABSTRACT

The invention relates to a method for producing a ferromagnetic component (17, 33) for a torque sensor for detecting a torque applied to a steering shaft of a motor vehicle, by providing a sheet-metal element composed of a ferromagnetic material, and by deforming the sheet-metal element to form the ferromagnetic component (17, 33), wherein an electric sheet steel is used as the ferromagnetic material for the sheet-metal element.

The invention relates to a method for producing a ferromagnetic component for a torque sensor for detecting a torque applied to a steering shaft of a motor vehicle. A sheet-metal element composed of a ferromagnetic material is provided, and the sheet-metal element is then deformed to form the ferromagnetic component. The invention also relates to a torque sensor for detecting a torque applied to a steering shaft of a motor vehicle, having at least one ferromagnetic stator part which is designed for conducting magnetic flux from a magnet to at least one flux conductor of the torque sensor, and through this to at least one magnetic sensor.

Torque sensors for detecting a torque applied to a steering shaft of a motor vehicle are already prior art. Such torque sensors may be used for example in electric steering systems. A torque sensor is known for example from the document US 2004/0194560 A1 and from the document DE 102 40 049 A1. The torque sensor device is in this case attached to two shaft parts, or sub-shafts, of the steering shaft which are situated opposite one another in an axial direction and which are connected to one another via a torsion bar. A magnet—for example a ring-shaped magnet—is arranged on the first shaft part, whereas a bracket with a magnetic stator is attached to the other shaft part, which magnetic stator is situated opposite the permanent magnet in a radial direction via a small air gap. By way of the stator—which is commonly composed of two separate stator parts—the magnetic flux of the magnet is conducted to a first and a second flux conductor, which then emit the magnetic flux to a magnetic sensor—for example a Hall sensor. The magnetic sensor is in this case situated between the two flux conductors.

A torque sensor of said type is furthermore known from the document DE 10 2007 043 502 A1.

Also known from the prior art are steering angle sensors which serve for detecting the present steering angle of the steering shaft. Such a device emerges, so as to be known, for example from the document DE 10 2008 011 448 A1. A rotational movement of the steering shaft is in this case transmitted via a gearing to a relatively small gearwheel, which bears a magnet. The rotation of the relatively small gearwheel is then detected by way of a magnetic sensor.

Also known are combined sensors, in the case of which the torque sensor device, on the one hand, and the steering angle sensor device, on the other hand, are formed integrally as a common structural unit. Such a device having a torque sensor and having a steering angle sensor is known for example from the document DE 10 2010 033 769 A1.

The known torque sensors thus have a magnetic circuit composed of a ring-shaped magnet, two stator parts with in each case one encircling ring-shaped disc, and multiple tooth elements, and also of two flux conductors for concentrating the magnetic field onto a magnetic field sensor. Both the stator parts and the flux conductors are in this case formed from a ferromagnetic material. In this very specific application, however, very high demands are placed on the ferromagnetic material with regard to the magnetic hysteresis. The use of normal iron materials—for example of standard deep-drawing quality DC04—is in this case not possible, and instead, special magnetically soft alloys are required in order to obtain an adequately good characteristic curve of the torque sensor, in particular a low level of hysteresis. The known alloys used for the production of the stator parts and of the flux conductors normally have a nickel fraction (Ni) of 30% to 80%. This has the disadvantage that said alloys constitute a considerable cost factor owing to the high price of nickel, and the production of torque sensors is thus relatively expensive in relation to other vehicle components. Furthermore, an iron-nickel alloy is also associated with further disadvantages with regard to production and coefficient of expansion.

It is an object of the invention to propose a method, which is improved in relation to the prior art, for producing a ferromagnetic component for a torque sensor of a vehicle steering shaft, and to propose an improved torque sensor.

Said object is achieved according to the invention by way of a method and by way of a torque sensor having the features according to the respective independent patent claims. Advantageous embodiments of the invention are the subject of the dependent patent claims, of the description and of the figures.

A method according to the invention serves for the production of a ferromagnetic component for a torque sensor for detecting a torque applied to a steering shaft of a motor vehicle. A sheet-metal element composed of a ferromagnetic material is provided and is deformed to form the ferromagnetic component. It is provided according to the invention that an electric sheet steel is used as the ferromagnetic material for the sheet-metal element, and the sheet-metal element is thus provided from electric sheet steel.

According to the invention, instead of using an iron-nickel alloy for the production of the ferromagnetic component, an alternative material is proposed, specifically electric sheet steel. This magnetically soft material constitutes an iron-silicon alloy which, in particular, has a silicon fraction of 2% to 4%. Here, the invention is based on the realization that an electric sheet steel of said type can also be particularly well-suited to the present application, specifically to a torque sensor of a steering shaft, and furthermore also has advantages in relation to an iron-nickel alloy. It has been found that good magnetically soft characteristics can be obtained even with an electric sheet steel of said type, in particular with a non-grain-oriented, semi-processed electric sheet steel. In relation to an iron-nickel alloy, an electric sheet steel has advantages in particular with regard to costs, production outlay and coefficient of thermal expansion.

What have proven to be particularly suitable for the present application are so-called non-grain-oriented (NGO) electric sheet steels which exhibit uniform magnetic characteristics both in the rolling direction and transversely with respect thereto. This is advantageous in the case of a torque sensor because such torque sensors are rotationally symmetrical and should thus advantageously have uniform magnetic characteristics. This is now ensured through the use of a non-grain-oriented electric sheet steel.

A basic distinction is made between so-called fully processed and semi-processed electric sheet steels as semifinished parts. For the production of electric motors or transformers, use is normally made, in the prior art, of fully processed electric sheet steels, which require no further heat treatment in order to generate the required magnetically soft characteristics. It has however been found that, for the use in a torque sensor of a steering shaft, said magnetically soft characteristics are not yet adequate. For this reason, in one embodiment, it is proposed that a semi-processed electric sheet steel be used, which can preferably be subjected to a heat treatment after the shaping or after the deformation to form the ferromagnetic component. This leads to very good results with regard to the magnetically soft characteristics of the torque sensor, and in particular to a relatively low level of magnetic hysteresis.

In one embodiment, it is thus provided that, after the deformation of the sheet-metal element to form the ferromagnetic component, an annealing process of the component is performed. This embodiment is based on the realization that, for the use in a torque sensor, the magnetically soft characteristics of the electric sheet steel are not yet one hundred percent adequate. Particularly good magnetic hysteresis is made possible for the first time by way of said heat treatment of the component.

In this context, standard annealing at temperatures of lower than 840° C. has proven to be inadequate. Much better magnetically soft characteristics can in this case be achieved by way of annealing of the component at considerably higher temperatures of higher than 850° C., in particular from a value range from 850° C. to 1250° C., more preferably at a temperature of 1100° C. to 1150° C.

Here, it has furthermore proven to be advantageous if said annealing process or the heat treatment of the component is performed for longer than two hours, in particular longer than three hours. The time duration of the annealing process may for example be four hours or five hours. This further improves the magnetically soft characteristics of the torque sensor.

A further improvement is attained if the annealing process of the component is performed in a decarbonizing atmosphere, in particular a decarbonizing hydrogen atmosphere. In this way, carbon can be extracted from the component, which further improves the magnetically soft characteristics, and in particular the magnetic hysteresis.

After the annealing process, a cooling process of the component is preferably performed. During said cooling process, an oxidation process of the component is preferably performed. Specifically, electric sheet steels begin to corrode even in the presence of small amounts of moisture. Therefore, corrosion prevention measures are necessary even in the case of the component being installed into a sealed housing. Here, the conventional coating methods, such as for example lacquering or a galvanic protective layer, have proven to be disadvantageous because these methods are associated with additional working steps, with the associated disadvantages. For this reason, in this embodiment, targeted oxidation of the component during the cooling process, that is to say immediately after the annealing, is proposed. This approach has the advantage that the oxidation of the component is performed at the same time as the cooling process, and thus the production duration of the component is not influenced. Therefore, no additional working steps for corrosion prevention measures are necessary.

The oxidation process is preferably performed at a temperature of the component of lower than 600° C., in particular lower than 550° C. Specifically, at this temperature, the optimum magnetically soft characteristics of the component have already been set.

A practical implementation of the oxidation process consists in the dewpoint of the protective gas atmosphere being considerably increased through the admixing of water vapour. Then, a dense oxide layer composed of magnetite forms on the component, which ensures adequate protection against corrosion. The reaction equation for this is as follows:

3Fe+4H₂O(g)<->Fe₃O₄+4H₂(g).

In particular in the case of a continuous furnace, this oxidation process can be integrated in a highly favourable manner in the cooling zone, such that no additional handling of the components is necessary. Furthermore, it is possible here for the residual heat to be utilized, such that the components do not have to be reheated.

The annealing process can thus be performed in a continuous furnace. In addition to the abovementioned advantage of the handling and the presence of residual heat, the use of a continuous furnace additionally has the advantage that, through the provision of suitable gas guidance, atmospheric separation between the annealing region with a low dewpoint and the oxidation region with a high dewpoint can be made possible without great outlay.

As a component for the torque sensor, it is preferable for a stator part for conducting magnetic flux to be produced, which stator part has a ring-shaped disc and has a multiplicity of tooth elements which are arranged so as to be distributed in a circumferential direction of the ring-shaped disc and which project, or are bent away, from the ring-shaped disc in an axial direction.

These stator parts are normally produced from a material strip by way of punching and bending. Thus, in this case, the deformation is realized by way of punching and bending. However, it has now been found that the most highly suitable electric sheet steels are relatively brittle. To reduce the risk of tearing during the bending of the tooth elements, it is proposed in one embodiment that, during the deformation of the sheet-metal element to form the stator part, bending of the tooth elements with a relatively large bend radius, specifically from 0.8 mm to 2 mm, is performed.

In addition or alternatively, it is also possible, as a component for the torque sensor, for a flux conductor to be produced which serves for conducting magnetic flux from the stator part to a magnetic sensor. Thus, by way of said flux conductor, the magnetic field is concentrated onto the magnetic sensor.

The invention may also relate to a method for producing a torque sensor itself, in the case of which, for the torque sensor, it is firstly the case that a component is produced in accordance with the method according to the invention described above, and subsequently, the torque sensor is assembled using said component. The torque sensor is designed for detecting a torque applied to a steering shaft of a motor vehicle.

The invention also relates to a torque sensor for detecting a torque applied to a steering shaft of a motor vehicle, having at least one ferromagnetic stator part which is designed for conducting magnetic flux from a magnet to at least one flux conductor of the torque sensor, and through the flux conductor to at least one magnetic sensor. The flux conductor serves for concentrating the magnetic flux on the magnetic sensor. According to the invention, the stator part and/or the flux conductor is formed from electric sheet steel.

The preferred embodiments proposed with reference to the method according to the invention, and the advantages thereof, apply correspondingly to the torque sensor according to the invention.

Further features of the invention will emerge from the claims, from the figures and from the description of the figures. All of the features and combinations of features mentioned above in the description, and the features and combinations of features mentioned below in the description of the figures and/or shown in the figures alone, may be used not only in the respectively specified combination but also in other combinations or individually.

The invention will now be discussed in more detail on the basis of a preferred exemplary embodiment and with reference to the appended drawings.

In the drawings:

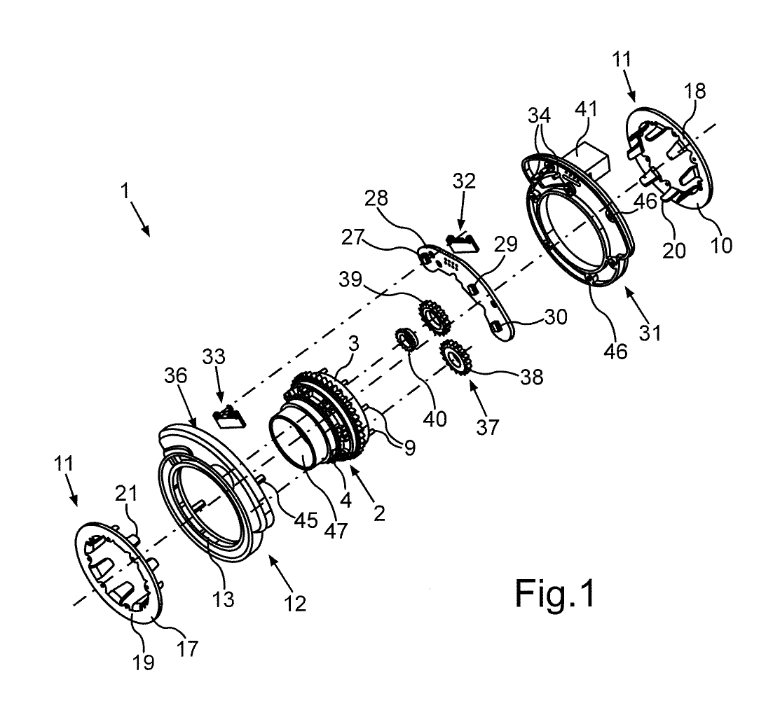

FIG. 1 is a schematic exploded illustration of an integrated device for a motor vehicle having a torque sensor and having a steering angle sensor;

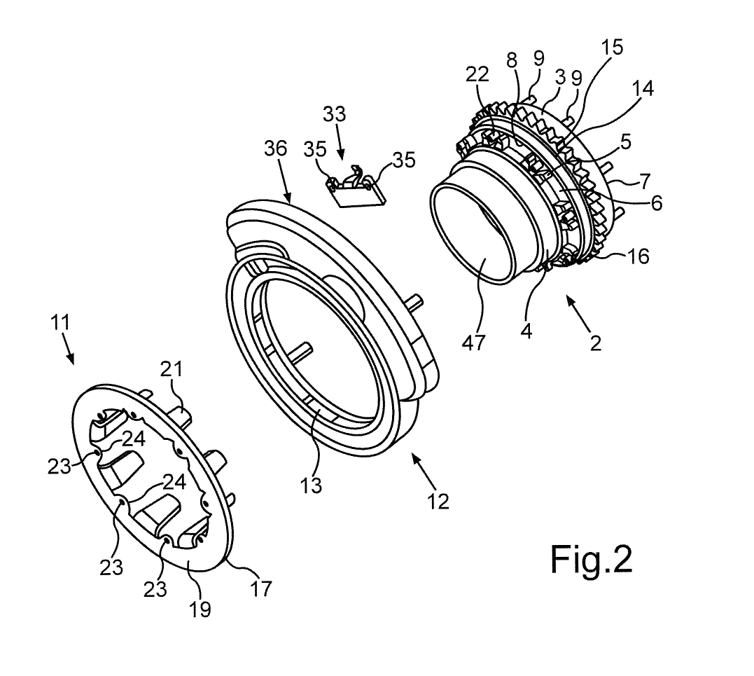

FIG. 2 is an enlarged illustration of a region of the device as per FIG. 1;

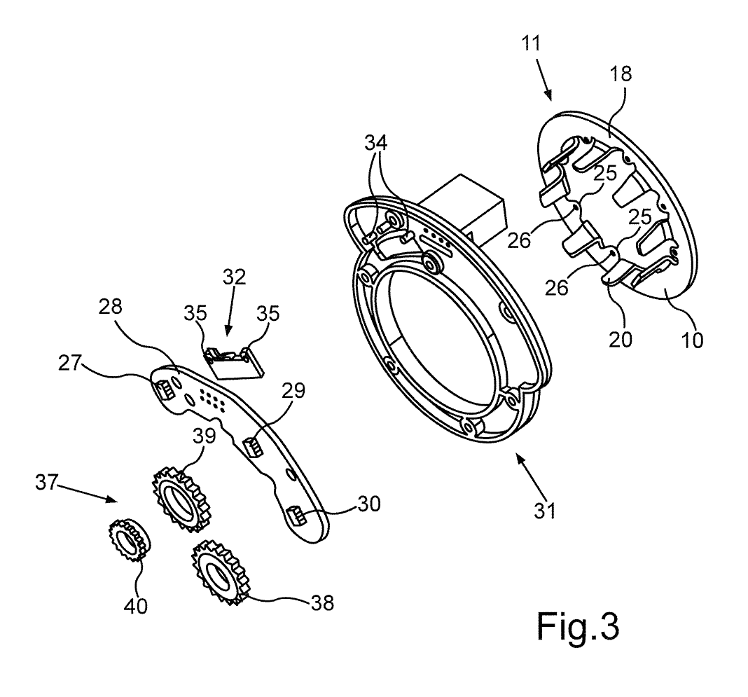

FIG. 3 is an enlarged illustration of a further region of the device as per FIG. 1; and

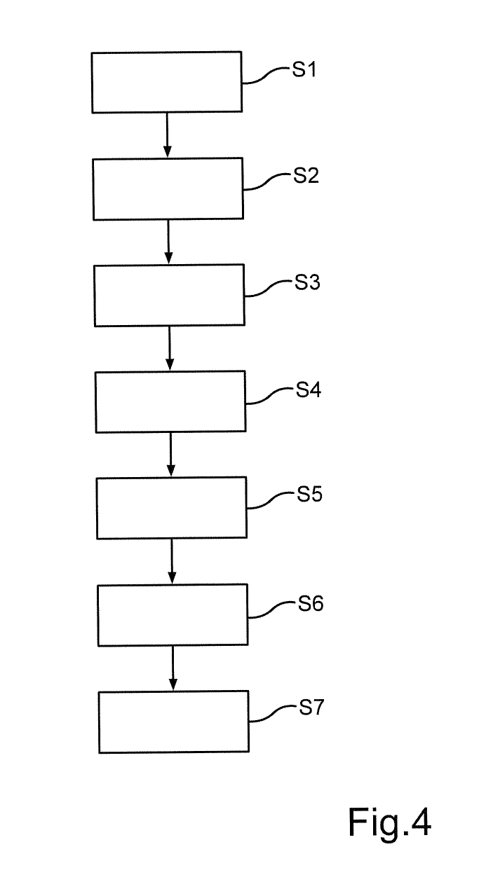

FIG. 4 shows a flow diagram of a method according to an embodiment of the invention.

A device according to an embodiment of the invention, as illustrated in FIG. 1 and designated as a whole by 1, comprises both a torque sensor and a steering angle sensor. The torque sensor serves for measuring a torque applied to a steering shaft of a motor vehicle. The steering angle sensor serves for detecting the present steering angle of the steering shaft. The device 1 is in the form of an integral structural unit, such that an integral sensor device is created which is designed both to detect the torque and to measure the steering angle.

The steering shaft of the vehicle comprises two shaft parts which are connected to one another via a torsion bar (not illustrated in the figures). A bracket 2 is attached rotationally conjointly to one of the shaft parts, whereas a magnet (not illustrated in the figures)—specifically a permanent magnet, for example in the form of a ring-shaped magnet—is held rotationally conjointly on the other shaft part. The bracket 2 may be a plastics part of unipartite form, and/or a cast component. Optionally, the bracket 2 may also be equipped with a sleeve 47, composed for example of metal, or else with other fastening elements such as lugs, hooks, clips and the like, for fastening the bracket 2 to the associated shaft part.

The components of the torque sensor are substantially as follows: the stated permanent magnet, a magnetic stator 11 with two identical stator parts 10, 17, two flux conductors 32, 33, and a magnetic sensor 27, which is positioned on a printed circuit board 28. By contrast, the steering angle sensor includes the following: two magnetic field detectors or magnetic sensors 29, 30, a gearing 37 with rotary transmission elements in the form of gearwheels 38, 39, 40, and a rotor 15, which is moulded onto the bracket 2.

As can be seen in particular from FIG. 2, the bracket 2 comprises two cylindrical regions arranged axially adjacent to one another, specifically firstly a first cylindrical axial region 3 and a second axial region 4, the latter being arranged offset in an axial direction and situated concentrically with respect to the first region 3 and having a somewhat smaller diameter. The first axial region 3 is connected to the second axial region 4 by way of a multiplicity of strut-like or spoke-like connecting elements 5 which are arranged so as to be distributed in a circumferential direction. Between the connecting elements 5 there are formed radial cutouts 6, which are passage openings.

The first axial region 3 has two axial rim edges, specifically, at one side, a first, outer rim edge 7 and, at the other side, a second, axial rim edge 8, which faces toward the second axial region 4.

On the first axial rim edge 7, there is formed a multiplicity of axial pins or studs 9 which, as axial projections, protrude parallel to one another in an axial direction from the edge 7. By way of said pins 9, the bracket 2 is connected to a first stator part 10 of the stator, which is denoted as a whole by 11.

The device 1 furthermore includes a housing 12, which additionally has the function of a sliding piece. The housing 12 has an inner sleeve 13, which is of ring-shaped encircling form and in which the first axial region 3 of the bracket 2 is received, such that the outer circumference of the first region 3 of the bracket 2 can slide on an inner circumference of the sleeve 13. Here, the first axial region 3 of the bracket 2 is inserted into the sleeve 13 as far as a flange 14 of the bracket 2, said flange being formed by a rotor 15 with a toothed structure 16. The rotor 15 with the toothed structure 16 is in this case moulded onto the first axial region 3.

Aside from the first stator part 10, the stator 11 additionally has a second stator part 17. Each stator part 10, 17 is in each case of unipartite form and has a ring-shaped, flange-like rim element 18 and 19 respectively, which extends outward in a radial direction, and also a multiplicity of tooth elements 20 and 21 respectively. The tooth elements 20, 21 project from the respective rim element 18, 19 in an axial direction, specifically in the direction of the first axial region 3 of the bracket 2. The tooth elements 20, 21 thus extend in an axial direction approximately parallel to an axis of rotation of the steering shaft. Here, the two stator parts 10, 17 are of identical form, such that the number of tooth elements 20 of the first stator part 10 is also equal to the number of tooth elements 21 of the second stator part 17.

For the fastening of the stator 11 to the bracket 2, it is firstly the case that the stator part 17 is mounted onto the second axial region 4 of the bracket 2, such that the tooth elements 21 are passed axially through the cutouts 6 between the connecting elements 5 and are supported on an inner circumference of the first axial region 3 of the bracket 2. After the mounting of the stator part 17 onto the second region 4 of the bracket 2, the tooth elements 21 are arranged in the interior of the first axial region 3 of the bracket 2, such that only the rim element 19 protrudes radially outward and is supported axially on the axial rim edge 8 of the first axial region 3 of the bracket 2.

During the mounting of the stator part 17 onto the second axial region 4 of the bracket 2, pins 22 of the first axial region 3, said pins being formed on the connecting elements 5 in the region of the rim edge 8, are received in corresponding passage openings 23 and are passed through said passage openings 23, which are formed in the rim element 19 of the stator part 17. Said passage openings 23 are formed in respective lugs 24 which protrude radially inward in the direction of the centre of the stator 11, or point toward the centre. Here, in each case one such lug 24 with a passage opening 23 is provided between in each case two adjacent tooth elements 21.

After the stator part 17 has been mounted on the second axial region 4 of the bracket 2, and thus after the pins 22 have been received in the passage openings 23, the free ends of the pins 22 can be deformed and thus processed to form rivet heads in order to ensure more secure seating of the stator part 17 on the bracket 2.

The other stator part 10 is fastened to the bracket 2 such that the tooth elements 20 are inserted into the interior of the first axial region 3 of the bracket 2 from that axial face side of the bracket 2 which is situated opposite the stator part 17, or from the side of the rim edge 7. Here, the tooth elements 20 slide on the inner circumference of the cylindrical region 3. In the assembled state, the tooth elements 20 are situated in each case between two adjacent tooth elements 21 of the other stator part 17, and bear against the inner circumference of the region 3. The stator part 10 also has a multiplicity of lugs 25, in which there is formed in each case one passage opening 26. The corresponding pins 9 which are formed on the rim edge 7 of the bracket 2 are passed through said passage openings 26. The free ends of said pins 9 are deformed to form rivet heads, and thus a secure fastening of the stator part to the bracket 2 is ensured.

It is basically possible for the two stator parts 10, 17 to be fixed to the bracket 2 in a wide variety of ways. The combination of pins 9 and 22 and passage openings 26 and 23 represents merely one exemplary embodiment. It is for example also possible for the stator parts 10, 17 to be fixed to the bracket 2 by way of holding rings, which are fixed to the bracket 2 by way of laser welding or else by way of ultrasound welding.

The torque sensor has a magnetic sensor 27 which is arranged on a printed circuit board 28. The magnetic sensor 27 is for example in the form of an electronic SMD component which is soldered directly to the printed circuit board 28 by way of solderable attachment surfaces. The corresponding technology is referred to as “surface mounting technology”.

The printed circuit board 28 is a common printed circuit board both for the magnetic sensor 27 of the torque sensor and for components of the steering angle sensor. Specifically, magnetic field detectors or sensor elements 29, 30 of the steering angle sensor, which are likewise in the form of SMD components, are also arranged on the printed circuit board 28.

For the closure of the housing 12, the device 1 comprises a cover 31.

The device 1 furthermore comprises, in the exemplary embodiment, two flux conductors 32, 33 which belong to the torque sensor. The two flux conductors 32, 33 are fastened, on the one hand, to the cover 31 and, on the other hand, to the housing 12. For this purpose, the cover 31 has two pins 34 which are passed through corresponding passage openings 35 in the flux conductor 32. Corresponding pins are also provided on the side of the housing 12 for the second flux conductor 33. By deformation of the pins 34, it is possible for rivet heads to be formed, which ensure effective and operationally reliable fixing of the flux conductors 32, 33 to the cover 31 and to the housing 12.

The housing 12 has a receptacle 36 in which both the printed circuit board 28 with the components 27, 29, 30 and also a gearwheel mechanism 37 of the steering angle sensor device can be accommodated. The gearwheel mechanism 37 has two gearwheels 38, 39, the teeth of which engage into those of the rotor 15 and are thereby rotatably coupled to the rotor 15 and to the bracket 2. In the gearwheel 38 there is arranged a permanent magnet. The axis of rotation of the gearwheel 38 is in this case parallel to the axis of rotation of the steering shaft. A second partial sensor system of the steering angle sensor device comprises the gearwheel 39, which, as an intermediate gearwheel, is coupled rotatably to a drive gearwheel or pinion 40. The drive gearwheel 40 in turn comprises a permanent magnet. The gearwheels 38, 39, 40 are accommodated and rotatably mounted in the receptacle 36 of the housing 12. In the receptacle 36 there is provided an internal toothing on which the drive gearwheel 40 can roll along a cycloid. For this purpose, the bore of the gearwheel 39 is of eccentric form. The printed circuit board 28 and the cover 31 are formed as counterparts to the receptacle 36, and enclose the gearing 37 from above. The magnetic field detectors 29, 30 are, in the exemplary embodiment, Hall sensors. The magnetic field detectors 29, 30 come to lie opposite the permanent magnets of the gearwheels 40 and 38 respectively. Here, said magnetic field detectors are perpendicular to the axis of rotation of the gearwheels 38, 39. The magnetic field detector 29 comes to lie on the axis of rotation of the gearwheel 39, whereas the magnetic field detector 30 is seated perpendicular to the axis of rotation of the gearwheel 38.

In typical vehicle steering systems, a range from five to seven full rotations of the steering shaft is uniquely detected. In order to uniquely determine the absolute rotational angle even in the case of more than one full rotation of the steering shaft, two assemblies are used. One assembly forms a rotation sensor (revolution sensor) and comprises the gearwheels 39, 40 and the magnetic field detector 29. For example, a transmission ratio of rotor 15 to gearwheel 40 of 6:1 is selected. The other assembly serves for the fine determination of the rotational angle (angle sensor) and comprises substantially the gearwheel 38, with its permanent magnet, and the magnetic field detector 30. For example, for the transmission ratio of rotor 15 to gearwheel 38, a value of 1:3 is selected. From the two gearwheel angles measured by way of the magnetic field detectors 29, 30, the rotational angle of the steering shaft can be directly calculated in a known manner by way of the Nonius principle. Suitable calculation methods for this purpose are known from the prior art and are disclosed for example in DE 195 06 938 A1 and DE 199 62 241 A1.

Alternatively, it is also possible for a “small Nonius” to be selected for the transmission ratio in order to be able to determine the present steering angle. Here, it is possible to dispense with the gearwheel 40, and the two gearwheels 38, 39 may be equipped with in each case one magnet. The gearwheels 38, 39 then have different numbers of teeth, such that, over the full steering angle range from 5 to 7 rotations of the steering column, it is for example the case that the gearwheel 39 rotates once more often than the gearwheel 38. In this way, too, it is possible to infer the actual steering angle.

In the cover 31 there may also be integrated a plug connector 41 by way of which the components 27, 29, 30 can be electrically connected to an external control unit. By way of the plug connector 41, an electrical connection is thus produced between the device 1, on the one hand, and a control unit, on the other hand.

If the flux conductors 32, 33 are fastened to the cover 31 and to the housing 12 respectively, the flux conductors 32, 33 extend in a radial direction and thus parallel to the rim elements 18, 19. The two flux conductors 32, 33 are in this case arranged on mutually opposite axial sides of the printed circuit board 28, wherein at least one of the flux conductors 32, 33 is also situated axially between the rim elements 18, 19. Here, the flux conductor 32 is situated with a small spacing to the rim element 18, whereas the second flux conductor 33 is arranged with a small spacing to the rim element 19.

The focus of interest is now on the production of the magnetically soft or ferromagnetic components, specifically the stator parts 10, 17, on the one hand, and the flux conductors 32, 33, on the other hand. A method for producing said components 10, 17, 32, 33 will now be discussed in more detail with reference to the flow diagram as per FIG. 4. In step S1, an electric sheet steel in the form of a material strip is provided as a semifinished part. The electric sheet steel is a semi-processed, non-grain-oriented electric sheet steel. In a further step S2, a sheet-metal element is separated off from the material strip by way of a suitable severing method, for example by cutting. In a further step S3, a deformation process is performed: the sheet-metal element is deformed to form the component 10, 17, 32, 33. The deformation is performed for example by way of punching and bending. Here, in particular in the case of the stator parts 10, 17, it is ensured that, during the bending of the tooth elements 20, 21, a corresponding bending radius is set, specifically from 0.8 mm to 2 mm. This may also apply to the two flux conductors 32, 33.

The components 10, 17, 32, 33 are then supplied, in a further step S4, to a continuous furnace. In a step S5, it is firstly the case that an annealing process is performed at a temperature of, for example, 1150° C., for a correspondingly long duration of up to several hours, and simultaneously in a decarbonizing hydrogen atmosphere. Said annealing process of the components 10, 17, 32, 33 may for example last four or five hours. In a further step S6, the annealing is followed by cooling of the components 10, 17, 32, 33. During the cooling process, an oxidation process is performed, for example by virtue of water vapour being supplied. Here, the following reaction takes place:

3Fe+4H₂O(g)<>Fe₃O₄+4H₂(g).

Here, the oxidation process is preferably first initiated when the temperature of the components 10, 17, 32, 33 falls below, for example, 550° C. The method then ends in a step S7.

The method may be summarized, overall, as follows:

Instead of the expensive nickel material, it is sought to use a cheaper FeSi material from the electric sheet steel sector for the stators. So-called non-grain-oriented (NGO) electric sheet steels are suitable, which exhibit uniform magnetic characteristics both in the rolling direction and transversely with respect thereto. This is advantageous because the stators are rotationally symmetrical.

Such NGO electric sheet steels are widely used, in different thicknesses and magnetic qualities, for the production of electric motors or transformers. Here, use is normally made of so-called fully processed qualities, which require no further heat treatment for the generation of the required magnetically soft characteristics. For the use in a torque sensor, said characteristics are however not yet adequate. One alternative is the use of semi-processed electric sheet steels, which are subjected to a heat treatment after the shaping process. Said heat treatment is typically performed at temperatures of lower than 840° C. The magnetically soft characteristics that can be achieved in the case of this standard annealing are however likewise not yet adequate. Much better magnetically soft characteristics can be achieved by way of annealing at considerably higher temperatures of up to 1150° C., for a correspondingly long duration of up to several hours, and simultaneously in a decarbonizing hydrogen atmosphere with a very low dewpoint. The annealing process may be performed either in batches in a hood-type annealing furnace or continuously in a continuous furnace. The best magnetically soft characteristics are achieved through the selection of a semifinished part with low power loss. The parameter of coercivity, which is of importance for the hysteresis of the torque sensor, may lie considerably below 25 Nm, which is significantly below the conventional value for standard applications.

The stators are normally produced from material strip by way of punching and bending. However, the most highly suitable electric sheet steels are rather brittle. To reduce the risk of tearing during the bending of the fingers, a correspondingly large bending radius is required. This also makes it difficult for the rim of the stator to be cranked or profiled. A flat rim of the stator is thus preferred.

Electric sheet steels begin to corrode even in the presence of small amounts of moisture. Therefore, corrosion prevention measures are necessary even in the case of installation in sealed housings. The conventional coating methods, such as lacquering or a galvanic protective layer, are additional working steps with corresponding costs, and are therefore ruled out. What is proposed is targeted oxidation of the components during the cooling phase, that is to say after the annealing to optimum magnetically soft characteristics, typically in the temperature range below 550° C. For this purpose, the dewpoint of the protective gas atmosphere is considerably increased (through the admixing of water vapour). A thick oxide layer or passivation layer composed of magnetite forms on the iron metal sheet, which offers adequate protection of the components against corrosion.

In particular in the case of a continuous furnace, said step can expediently be integrated in the cooling zone, such that no additional handling of the components is necessary. Furthermore, the residual heat can be utilized, and reheating is not necessary. Here, suitable gas guidance ensures atmospheric separation between the annealing region with a low dewpoint and the oxidation region with a high dewpoint.

1. A method for producing a ferromagnetic component for a torque sensor for detecting a torque applied to a steering shaft of a motor vehicle, comprising:
providing a sheet-metal element composed of a ferromagnetic material; and
deforming the sheet-metal element to form the ferromagnetic component, wherein
an electric sheet steel is used as the ferromagnetic material for the sheet-metal element.

2. The method according to claim 1, wherein the sheet-metal element is provided from a non-grain-oriented electric sheet steel.

3. The method according to claim 1, wherein the sheet-metal element is provided from a semi-processed electric sheet steel.

4. The method according to claim 1, wherein, after the deformation, an annealing process of the component is performed.

5. The method according to claim 4, wherein, during the annealing process, the component is exposed to a temperature of between 1100° C. to 1150° C.

6. The method according to claim 4, wherein the annealing process of the component is performed for longer than 3 hours.

7. The method according to claim 4, wherein the annealing process of the component is performed in a decarbonizing atmosphere.

8. The method according to claim 4, wherein, during a cooling process after the annealing process, an oxidation process or passivation process of the component is performed.

9. The method according to claim 8, wherein the oxidation process or passivation process is performed at a temperature of the component of lower than 550° C.

10. The method according to claim 8, wherein the oxidation process or passivation process is performed by way of a supply of water vapour.

11. The method according to claim 4, wherein the annealing process is performed in a continuous furnace.

12. The method according to claim 1, wherein, as a component for the torque sensor, a stator part for conducting magnetic flux is produced, which stator part has a ring-shaped disc and has a multiplicity of tooth elements which are arranged so as to be distributed in a circumferential direction of the ring-shaped disc and which project from the ring-shaped disc in an axial direction.

13. The method according to claim 12, wherein, during the deformation of the sheet-metal element to form the stator part, bending of the tooth elements with a bend radius of 0.8 mm to 2 mm is performed.

14. The method according to claim lone of the preceding claims, characterized in that, as a component for the torque sensor, a flux conductor for conducting magnetic flux from a stator part to a magnetic sensor is produced.

15. A torque sensor for detecting a torque applied to a steering shaft of a motor vehicle, comprising:
at least one ferromagnetic stator part which is designed for conducting magnetic flux from a magnet to at least one flux conductor of the torque sensor, and through this to at least one magnetic sensor, characterized in that
wherein the stator part and/or the flux conductor is formed from electric sheet steel.
